(19) United States
(12) Patent Application Publication
(10) Pub. No.: US 2019/0384825 A1
(43) Pub. Date: Dec. 19, 2019

(54) METHOD AND DEVICE FOR DATA PROTECTION AND COMPUTER READABLE STORAGE MEDIUM

(71) Applicant: EMC IP Holding Company LLC, Hopkinton, MA (US)

(72) Inventors: Haitao Li, Chengdu (CN); Lanjun Liao, Chengdu (CN); Qingxiao Zheng, Chengdu (CN); Ke Li, Chengdu (CN); Guangwei Yang, Chengdu (CN)

(21) Appl. No.: 16/146,755

(22) Filed: Sep. 28, 2018

(30) Foreign Application Priority Data
Jun. 15, 2018 (CN) 201810622741.1

(51) Int. Cl. G06F 17/30; G06F 11/14

(52) U.S. Cl. CPC G06F 17/30005; G06F 11/1464; G06F 17/3012; G06F 17/30297; G06F 17/30097; G06F 11/1451

(57) ABSTRACT

Embodiments of the present disclosure relate to a method, a device and a computer readable storage medium for data protection. The method comprises in response to obtaining first metadata associated with data protection, determining a size of the first metadata. When the size of the first metadata exceeding a predetermined size, storing an indication of the first metadata in a first format, and storing the first metadata in a second format, the first format being associated with a fixed size of storage space, and the second format occupying larger storage space than the first format. Further, when the size of the first metadata fails to exceed the predetermined size, storing the first metadata in the first format.

### FIELD

Embodiments of the present disclosure relate to data protection, and more specifically, to a method, a device and a computer readable storage medium for data protection.

### BACKGROUND

For a data protection (DP) system, metadata records basic information of users, domains, machines and backups with hierarchy. It also indicates a position for real data of backups. For a quick querying, the metadata is designed with a specific format and stored in a specified order. Most DP systems use a data structure of fixed-size to reserve space for each metadata item instead of using a dynamic language or a standard database.

During a long life cycle of a product and as a result of the addition of new features the data structure of the metadata may fail to meet new requirements of the new features.

### SUMMARY

Embodiments of the present disclosure provide a method for data protection, a data protection system, a computer readable storage medium and a computer program product.

In general, in one aspect, there is provided a method of data protection. The method comprising: in response to obtaining first metadata associated with data protection, determining a size of the first metadata; in response to the size of the first metadata exceeding a predetermined size, storing an indication of the first metadata in a first format, and storing the first metadata in a second format, the first format being associated with a fixed size of storage space, and the second format occupying larger storage space than the first format; and in response to determining that the size of the first metadata fails to exceed the predetermined size, storing the first metadata in the first format.

In general, in one aspect, there is provided a data protection system. The data protection system comprising: a processing unit; and a memory coupled to the processing unit and including instructions stored thereon which, when executed by the processing unit, cause the device to implement acts, comprising: in response to obtaining first metadata associated with data protection, determining a size of the first metadata; in response to the size of the first metadata exceeding a predetermined size, storing an indication of the first metadata in a first format, and storing the first metadata in a second format, the first format being associated with a fixed size of storage space, and the second format occupying larger storage space than the first format; and in response to determining that a size of the first metadata fails to exceed the predetermined size, storing the first metadata in the first format.

In general, in one aspect, there is provided a computer readable storage medium having machine executable instructions stored thereon which, when executed in at least one processor, causing the at least one processor to implement a method according to the first aspect.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In example embodiments of present disclosure, the same reference symbols usually represent the same components.

FIG. 1 is a schematic diagram illustrating a hierarchical structure of metadata in accordance with some embodiments of the present disclosure;

FIG. 2 is a flowchart illustrating a method of data protection in accordance with some embodiments of the present disclosure;

FIG. 3 is a schematic diagram for creating metadata in accordance with some embodiments of the present disclosure;

FIG. 4 is a schematic diagram for querying metadata in accordance with some embodiments of the present disclosure; and

FIG. 5 is a schematic block diagram illustrating an example device that may be used to implement embodiments of the present disclosure in accordance with some embodiments of the present disclosure.

### DETAILED DESCRIPTION OF EMBODIMENTS

The preferred embodiments of the present disclosure will be described in more details with reference to the drawings. Although the preferred embodiments of the present disclosure are illustrated in the drawings, it should be understood that the present disclosure can be implemented in various manners and should not be limited to the embodiments explained herein. On the contrary, the embodiments are provided to make the present disclosure more thorough and complete and to fully convey the scope of the present disclosure to those skilled in the art.

As used herein, the term “includes” and its variants are to be read as open-ended terms that mean “includes, but is not limited to.” The term “or” is to be read as “and/or” unless the context clearly indicates otherwise. The term “based on” is to be read as “based at least in part on.” The terms “one example embodiment” and “one embodiment” are to be read as “at least one example embodiment.” The term “another embodiment” is to be read as “at least one another embodiment.” The terms “first”, “second” and so on can refer to same or different objects. The following text can also include other explicit and implicit definitions.

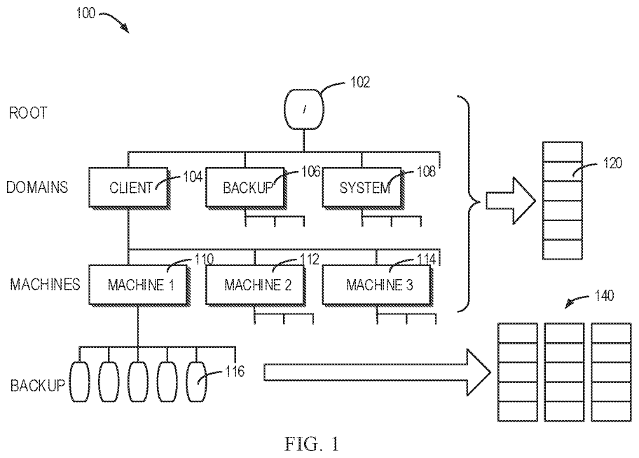

Metadata is data that provides information about other data. FIG. 1 illustrates a hierarchical structure of metadata of a server in accordance with some embodiments of the present disclosure. As shown in FIG. 1, a root node 102 includes one or more domains, such as a client 104, a backup 106 and a system 108. Each domain may include one or more machines. For instance, as shown in FIG. 1, the client 104 includes machines 110, 112 and 114 and each machine may run the same or different operating systems. Metadata associated with the root node 102 to machines 110, 112 and 114 may be referred to as machine metadata which may be stored in a user data stripe file 120 in the form of a list.

For example, machine metadata may record information of registered clients. In a data protection system, a predetermined length (for instance, 64 bytes in length) is reserved for some fields, which is completely sufficient for a name of a real machine. However, for new fields generated in a cloud platform, the limitation of length may need to be extended to 256 bytes, thus causing errors.

During operation of a machine, backup data would be generated. FIG. 1 illustrates metadata 116 associated with backup data of the machine 110, which is also referred to as backup metadata. For example, the metadata 116 may record backup information, such as time, a type, a position and so on, and may be stored in a data stripe file 140 in a form of a list. When the data protection system supports a new backup type, some new backup fields are needed to display some new logics. Therefore, it is necessary to extend the backup metadata.

On this basis, embodiments of the present disclosure provide a solution for data protection. In one or more embodiments, the solution includes extending data structure of metadata of existing data protection systems.

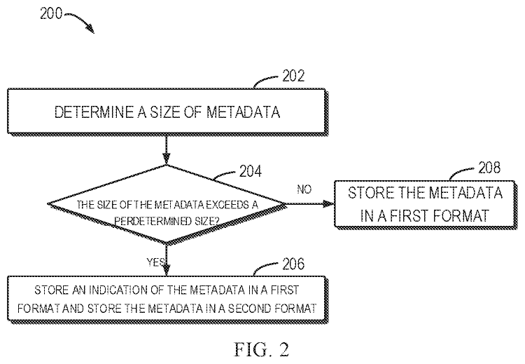

FIG. 2 is a flowchart illustrating a method 200 of data protection in accordance with some embodiments of the present disclosure. At block 202, in response to obtaining metadata associated with data protection, a size of the metadata is determined. For example, the metadata may be the machine metadata described with reference to FIG. 1 or the backup metadata.

At block 204, it is determined whether the size of the metadata exceeds a predetermined size. The predetermined size may be the largest possible size that is acceptable by a conventional format or a conventional data structure, which may be associated with the type of the metadata or the corresponding field.

If it is determined at block 204 that the size of the metadata exceeds the predetermined size, the method 200 may proceed to block 206. At the block 206, an indication of the metadata may be stored in a first format and the metadata may be stored in a second format. The first format is associated with a fixed size of storage space, and the second format occupies greater storage space than the first format. For example, the first format may include a first data structure which may specify a fixed size of storage space. For example, it can be a location addressing means of storage space, for instance. The second format may include a second data structure which may be used to store data items unsupported by conventional data protection systems. For example, it can be a content addressed means of storage. In some embodiments, the first format of data may be stored in one or more lists, and the second format of data may be stored in one or more lists different therefrom. In some embodiments, the indication of the metadata and the metadata may be stored simultaneously in the second format to provide a further verification, particularly in a case with position conflict.

If it is determined at block 204 that the size of the metadata fails to exceed the predetermined size, the method 200 may proceed to block 208 at which the metadata may be stored in the first format. For example, in a data protection system, a legacy data structure may still be used to record and display legacy data items. When the server is running, a large amount of legacy data items have been recorded in the server with a compact legacy data structure. With the method 200, an original way of operation of these data items is retained.

In some embodiments, the indication of the metadata may be a hash value of the metadata. For example, reference such as the hash value of the metadata is used to replace the legacy data structure of the metadata. Although the legacy data structure is smaller than an extended data structure, it is sufficient to store the hash value of the metadata. For example, metadata of a first data structure and an indication (such as a hash value) of metadata of a second data structure may be stored in one field. It is easy to identify whether the data structure is the first data structure or the second data structure. Extended data may be searched based on an indication (such as a hash value) of a record file of a content addressed storage (CAS). High performance is achieved by adding and querying positions based on hash values. However, it is to be understood that any other type of indications currently known or to be developed in the future may also be used, such as a method using index.

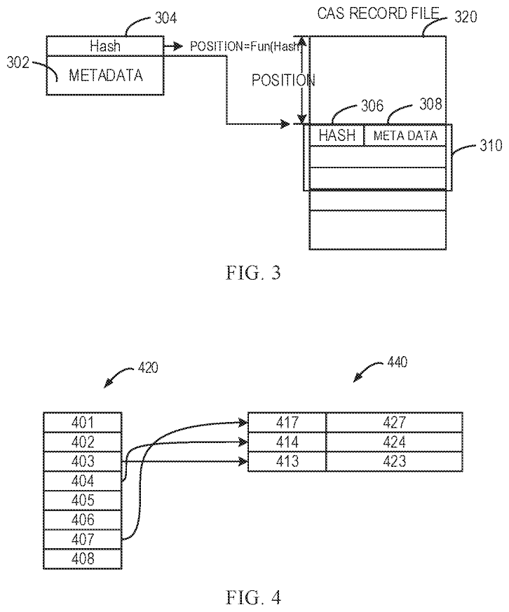

FIG. 3 is a schematic diagram illustrating metadata in accordance with an embodiment of the present disclosure. The size of metadata 302 exceeds a predetermined size and thus, it needs to be extended. When such data item of metadata is added, an additional record file 320 may be created in the server. For example, an extended data item is stored in the record file 320 in the form of content addressed storage (CAS). The hash value 306 of the extended data item is a key indicating the position of the data structure in the record file 320.

As shown in FIG. 3, a function (fun) may distribute a hash value 304 of the metadata 302 evenly in a range from 0 to 1, and multiply the length of the record file 320 to obtain the position of the metadata 302. The position represents a bucket 310 in the record file of the metadata 302. For example, one bucket is able to contain 10-20 data items.

For most of the cases, a first position in the bucket 310 is an item of the hash value 304. For example, in the bucket 310, a hash value 306 and metadata 308 are stored in the first position, and the hash value 306 is generally matched with the hash value 304. In some scenarios, the first position in the bucket 310 is occupied by another data item with the same position. Under this condition, the procedure may go to the next position of the bucket 310, until an empty place for an adding operation is found or the same hash value for a query operation is found. For example, if the bucket 310 is full and a new data item needs to be added to the bucket 310, the size of the bucket 310 may be increased, for instance, to double the size of the bucket 310. If there are more data items having position conflicts in a record file, more comparisons are to be performed when an adding or a querying operation is implemented.

In some embodiments, the method 200 includes: in response to receiving a query for metadata, corresponding data may be read from a storage position indicated by the query. If the data is the metadata, the data may be provided directly as the metadata. Conversely, if it is determined that the data is an indication (such as a hash value) of the metadata, the metadata may be read based on an indication of the metadata. For example, when the indication is the hash value, a position of the metadata may be determined based on the hash value, and the metadata is read from this position. To depict the query process more clearly, FIG. 4 shows a schematic diagram illustrating a method of querying metadata in accordance with some embodiments of the present disclosure. As shown in FIG. 4, a list 420 is a list representing metadata of machines 401-408, where machines 403, 404 and 407 store indications of respective metadata, such as the hash value. In a record file 440, the corresponding metadata and indications thereof are stored, and in the content addressed means of storage. For example, indications corresponding to 403, 404 and 407 are stored respectively at 413, 414 and 417, and metadata corresponding to 403, 404 and 407 is stored respectively at 423, 424 and 427.

For example, when a query for metadata associated with the machine 403 is received, data associated with the machine 403 may be found in the list 420. In this case, as it is not the metadata itself that is stored in the list 420, but the hash value thereof, the storage position of the metadata, for instance, the position in the record file 440, may be determined based on the hash value, and metadata 423 is read from the list 440. In this case, it may be determined through the hash value 413 whether the corresponding metadata is addressed to prevent the case of position collision. For example, when a query for metadata associated with the machine 401 is received, data associated with the machine 401 may be found in the list 420. In this case, as it is the metadata itself that is stored in the list 420, the corresponding metadata may be returned directly.

In some embodiments, a record file (such as the record file 320, 440) may be replicated to a remote server for backup. When recovering from a disaster, the record file may be acquired from a remote server for restoration. The record file is used to obtain real information of metadata. Therefore, the record file may be backed up and replicated to the remote server. After the replication, the function of indication or reference may be transferred to a remote server. Besides, upon disaster recovery, the same record file may be restored.

According to embodiments of the present disclosure, the method is compatible with current data protection systems and during an upgrading process, it is not necessary to perform a large amount of updating operations to the current data protection systems. Moreover, a deeper level of operation is only performed on a new type of metadata, thereby saving storage space. Because a content addressed mechanism of storage is utilized, the performance is not affected significantly. As the indication of metadata (such as a hash value) is stored and maintained in the list equivalently with legacy metadata, it has the same hierarchical structure as the legacy metadata, which can save operations of converting data items frequently.

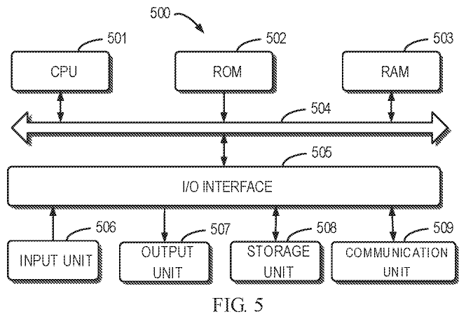

FIG. 5 is a schematic block diagram illustrating a device 500 that may be used to implement embodiments of the present disclosure. As illustrated, the device 500 comprises a central processing unit (CPU) 501 which can execute various appropriate actions and processing based on the computer program instructions stored in a read-only memory (ROM) 502 or the computer program instructions loaded into a random access memory (RAM) 503 from a storage unit 508. The RAM 503 also stores all kinds of programs and data required by operating the storage device 500. The CPU 501, ROM 502 and RAM 503 are connected to each other via a bus 504 to which an input/output (I/O) interface 505 is also connected.

A plurality of components in the device 500 are connected to the I/O interface 505, comprises: an input unit 506, such as a keyboard, a mouse and the like; an output unit 507, such as various types of displays, loudspeakers and the like; a storage unit 508, such as a magnetic disk, an optical disk and the like; and a communication unit 509, such as a network card, a modem, a wireless communication transceiver and the like. The communication unit 509 allows the device 500 to exchange information/data with other devices through computer networks such as Internet and/or various telecommunication networks.

Each procedure and processing as described above, such as the method 200, can be executed by the processing unit 501. For example, in some embodiments, the method 200 can be implemented as computer software programs, which are tangibly included in a machine-readable medium, such as the storage unit 508. In some embodiments, the computer program can be partially or completely loaded and/or installed to the device 500 via the ROM 502 and/or the communication unit 509. When the computer program is loaded to the RAM 503 and executed by the CPU 501, one or more steps of the above described method 200 are implemented.

The present disclosure may be a system, an apparatus, a device, a system, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but not limited to, an electronic storage device, a magnetic storage device, an optical storage device, an electromagnetic storage device, a semiconductor storage device, or any suitable combination thereof. More specific examples (a non-exhaustive list) of the computer readable storage medium would include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination thereof. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium, or downloaded to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, by means of state information of the computer readable program instructions, an electronic circuitry including, for example, programmable logic circuitry, field-programmable gate arrays (FPGA), or programmable logic arrays (PLA) can be personalized to execute the computer readable program instructions, thereby implementing various aspects of the present disclosure.

Aspects of the present disclosure are described herein with reference to flowchart and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which are executed via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which are executed on the computer, other programmable apparatus, or other device implement the functions/acts specified in the flowchart and/or block diagram block or blocks.

The flowchart and block diagrams illustrate the architecture, functionality, and operation of possible implementations of systems, methods and computer program products according to various embodiments of the present disclosure. In this regard, each block in the flowchart or block diagrams may represent a module, snippet, or portion of codes, which comprises one or more executable instructions for implementing the specified logical function(s). In some alternative implementations, the functions noted in the block may be implemented in an order different from those illustrated in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or by combinations of special purpose hardware and computer instructions.

The descriptions of the various embodiments of the present disclosure have been presented for illustration purposes, but are not intended to be exhaustive or limited to the embodiments disclosed. Many modifications and variations will be apparent to those of skilled in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method of data protection, comprising:
in response to obtaining first metadata associated with data protection, determining a size of the first metadata;
when the size of the first metadata exceeding a predetermined size:
storing an indication of the first metadata in a first format, and
storing the first metadata in a second format, the first format being associated with a fixed size of storage space, and the second format occupying larger storage space than the first format; and
when the size of the first metadata fails to exceed the predetermined size, storing the first metadata in the first format.

2. The method according to claim 1, wherein the indication of the first metadata is a hash value of the first metadata.

3. The method according to claim 1, further comprising:
in response to receiving a query for second metadata, reading data from a storage position indicated by the query; and
in response to determining that the data being read is an indication of the second metadata, reading the second metadata according to the indication of the second metadata.

4. The method according to claim 1, further comprising:
in response to receiving a query for second metadata, reading data from a storage position indicated by the query; and
in response to determining that the data being read is the second metadata, providing the second metadata.

5. The method according to claim 1, further comprising:
when the size of the first metadata exceeds the predetermined size, duplicating the first metadata to a server.

6. A device for data protection, comprising:
a processing unit;
a memory coupled to the processing unit and including instructions stored thereon which, when executed by the processing unit, cause the device to perform a method, the method, comprising:
in response to obtaining first metadata associated with data protection, determining a size of the first metadata;
when the size of the first metadata exceeding a predetermined size:
storing an indication of the first metadata in a first format, and
storing the first metadata in a second format, the first format being associated with a fixed size of storage space, and the second format occupying larger storage space than the first format; and
when the size of the first metadata fails to exceed the predetermined size, storing the first metadata in the first format.

7. The device according to claim 6, wherein the indication of the first metadata is a hash value of the first metadata.

8. The device according to claim 6, further comprising:
in response to receiving a query for second metadata, reading data from a storage position indicated by the query; and
in response to determining that the data being read is an indication of the second metadata, reading the second metadata according to the indication of the second metadata.

9. The device according to claim 6, further comprising:
in response to receiving a query for second metadata, reading data from a storage position indicated by the query; and
in response to determining that the data being read is the second metadata, providing the second metadata.

10. The device according to claim 6, further comprising:
when the size of the first metadata exceeds the predetermined size, duplicating the first metadata to a server.

11. A computer readable storage medium with computer executable instructions stored thereon, the computer executable instructions, when executed in at least one processor, causing the at least one processor to implement a method, the method comprising:
in response to obtaining first metadata associated with data protection, determining a size of the first metadata;
when the size of the first metadata exceeding a predetermined size:
storing an indication of the first metadata in a first format, and
storing the first metadata in a second format, the first format being associated with a fixed size of storage space, and the second format occupying larger storage space than the first format and
when the size of the first metadata fails to exceed the predetermined size, storing the first metadata in the first format

12. The computer readable storage medium of claim 11, wherein the indication of the first metadata is a hash value of the first metadata.

13. The computer readable storage medium of claim 11, the method further comprising:
in response to receiving a query for second metadata, reading data from a storage position indicated by the query; and
in response to determining that the data being read is an indication of the second metadata, reading the second metadata according to the indication of the second metadata.

14. The computer readable storage medium of claim 11, the method further comprising:
in response to receiving a query for second metadata, reading data from a storage position indicated by the query; and
in response to determining that the data being read is the second metadata, providing the second metadata.

15. The computer readable storage medium of claim 11, the method further comprising:
when the size of the first metadata exceeds the predetermined size, duplicating the first metadata to a server.
